(19) United States
(12) Patent Application Publication
(10) Pub. No.: US 2005/0008464 A1
(43) Pub. Date: Jan. 13, 2005

(54) Storage magazine

(76) Inventor: Jens Emmerling, Memmingen (DE)

Correspondence Address: ADAM EVANS, P.A.;(formerly Adams, Schwartz & Evans, P.A.), 2180 TWO WACHOVIA CENTER, CHARLOTTE, NC, 28282, US

(21) Appl. No.: 10/832,530

(22) Filed: Apr. 27, 2004

(30) Foreign Application Priority Data
Jul. 11, 2003 (DE) 103 31 741.4

(51) Int. Cl. B65G 1/133

(52) U.S. Cl. 414/331.03; 211/122

(57) ABSTRACT

A storage system, including a plurality of storage units located on a transport conveyor that has at least a U-shaped or randomly partially curved design. The storage units are arranged similarly parallel at least along straight areas of the transport conveyor. The storage units can be rotated on swivel axes that are oriented essentially at a right angle to the transport conveyor. During the movement of the storage unit (2) into the curved area of the transport conveyor the storage unit (2) remains essentially parallel to the next storage unit (2) and swivels on the swivel axis of the moved storage unit (2).

### TECHNICAL FIELD AND BACKGROUND OF INVENTION

The present invention relates to a storage system in which a plurality of storage units are located on a transport conveyor that has at least a U-shaped or randomly partially curved design and can be moved by means of a drive and the storage units are arranged similarly parallel at least along the straight areas of the transport conveyor and the storage units can be rotated on swivel axes that are oriented essentially at a right angle to the transport conveyor.

The invention is characterized by the fact that during the movement of the storage unit in the curved area of the transport conveyor the storage unit remains essentially similarly parallel to the next storage unit and swivels on the swivel axis of the moving storage unit.

Such storage and supply systems are known in the art. Most storage and supply systems are characterized by the fact that the storage units are designed as frames or containers, for example, which are fastened to an oval, driven conveyor and in which certain goods can be stored and transported.

The storage units in these systems are designed with specific grid dimensions (width×length). It is furthermore known in the art, at least for all currently functioning, efficient storage systems, to transport the storage units with the broad side strung together. With rectangular basic dimensions, this results in a very high space requirement, so that it is deemed advisable to transport the storage units with their long side strung together (i.e. oriented crosswise).

Such a system is known in the art from patent EP 0 571 658 B1. In this system, the storage units are oriented crosswise to the transport conveyor and fastened to the latter by means of a triangular frame. The storage units themselves in this system can rotate on a rotational axis of the frame and can be accessed from 2 sides. Upon reaching the turning point or the loading area the storage units must then be swiveled from their right-angle position to a position relative to the other storage units. For this purpose, the entire storage unit is swiveled on the rotational axis present on the fastening means and secured. Only then is it possible for the operator to load or pick.

The disadvantages of this solution are that a rotating movement in the access area is necessary, which necessitates a technically complex rotating device on each storage unit. A further disadvantage results from the fact that the goods stored in the storage unit are subjected to an unnecessarily large acceleration force due to the swivel movement, which can cause them to fall over or fall out. Although this danger can be compensated for by a slower swivel movement, this occurs at the expense of the overall speed of the storage system. The average access time increases, resulting in increased operator costs due to longer waiting times.

The space requirement of this system, especially in the picking area, is relatively high due to the ability of the storage units to swivel. Furthermore, the system necessitates considerable safety measures, since the operator must be prevented from being present in this area while the storage unit is turning. The operator can enter this area only after the storage unit is positioned, i.e. after the swivel movement has taken place in parallel orientation to the other storage units. The operator must leave the area before the storage system can be swiveled back into its normal position for transport. This also results in loss of time.

The currently known systems are designed essentially such that the shelf fields are aligned in longitudinal direction during transport and then are moved to transverse position upon reaching the loading or turning point. These systems have a relatively high space requirement, so that solutions have already been suggested that enable transport in transverse direction. Some shelf fields must be turned 180°, which takes place before or during loading or unloading of the storage units. This results in a significant loss of time. The space requirement in the operating area is increased, and the expense for the construction of the fastening and swivel apparatus on the transport system itself is considerable.

A further disadvantage arises due to the fact that the operator must enter the safety area of the system in order to access the stored goods or the shelf system itself.

Based on the above state of the art, the object of the present invention is to provide a storage system in which the afore-mentioned disadvantages no longer exist.

The invention is based on the state of the art as described above and proposes a storage system, in which a plurality of storage units are located on a transport conveyor that has at least a U-shaped or randomly partially curved design and can be moved by means of a drive and the storage units are arranged similarly parallel at least along the straight areas of the transport conveyor. The storage units can be rotated on swivel axes that are oriented at a right angle to the transport conveyor. During the movement of the storage unit in the curved areas of the transport conveyor, the storage unit remains essentially similarly parallel to the next storage unit. In the invention, therefore, a parallel oriented movement takes place without the entire storage unit having to be swiveled on the radius of the transport system or the transport conveyor. The storage unit always remains oriented parallel to the other storage units and especially in such a manner that the shelf fields remain crosswise to the transport conveyor also in the swivel area.

This enables in particular a transverse oriented arrangement of the storage unit to or on the transport conveyor.

### SUMMARY OF THE INVENTION

This solution eliminates the technical disadvantages of the state of the art, such that the essentially parallel movement of the storage unit to be swiveled in relation to the other storage units enables a considerably higher transport speed of the overall system, since the detrimental centrifugal force present in the swivel area in the state of the art systems no longer occurs to this degree. Furthermore, space is saved not only due to the transverse orientation on the straight areas of the transport conveyor, but likewise especially in the curved areas of the transport conveyor. Turning from the longitudinally oriented position into the transverse oriented position is no longer necessary, so that the space required due to the difference between the length and width of the storage unit is saved. The space saving for the overall storage system by the transverse orientation of all storage units is described above. Henceforth, this space will be available in a technically functioning storage system with transverse oriented storage units. Furthermore, it will be possible for the operator to reach into the storage unit or the operating area of the storage unit without having to enter the safety area within the curved areas of the transport conveyor. This is likewise now technically realizable at a reasonable expense with the now enabled orientation of the system in transverse position during swiveling.

By means of a guide mechanism it is possible to transport the storage units parallel to each other, especially in the curved areas of the transport conveyor. This is achieved very simply, for example by a storage unit that is guided by means of a journal or roller on a guide mechanism consisting of a rail or similar device. This is a very simple embodiment of the invention that enables an inexpensive design for the storage system according to the invention.

The guide mechanism consists of at least one steering guide and at least one pivoted steering rocker located on each of the storage units and on the transport conveyor. The storage unit is guided in the steering guide so that the parallel orientation is maintained in the curved area of the transport conveyor. For this purpose it is sufficient, for example, to position one steering rocker on the transport conveyor, which is then itself fastened to a storage unit so that it can rotate.

The steering rockers enable swiveling of the storage unit in the curved area of the transport conveyor with a minimal space requirement. By selecting a radius for the transport conveyor in the curved area of the transport conveyor so that the longitudinal rockers necessarily move toward each other when working together with the guide, the storage unit is also guided past the end of the straight transport conveyor at a distance. In this respect, it is advantageous to provide such a solution with at least two longitudinal rockers for each storage unit.

It is expedient to be able to insert or remove entire storage units into and from the system. For this purpose, it is necessary and expedient to provide the storage units and the transport conveyor with interfaces for coupling and uncoupling. All types of known interfaces for mechanical engineering or transport systems can be used for this. They can be controlled mechanically and/or electrically or magnetically.

The parallel arrangement of the steering guide and the transport conveyor upon which the invention is based ensures in a simple manner the parallel transport especially in the curved area of the transport conveyor. Thereby it is advantageous if the transport conveyor as a transport guide has a rail-like design.

An advantageous further embodiment of the invention provides for longitudinal rockers both between the transport conveyor and the storage unit and between the steering guide and the storage unit. This ensures a high degree of safety during operation in the curved area of the transport conveyor.

The steering guide can be designed as a guide rail or similar device according to one preferable embodiment of the invention.

The invention also provides for several storage units arranged one above the other with corresponding operator platforms to save space.

It is also advantageous if the access area for loading or picking of goods from the storage units is provided with a protective cover. The protective cover is provided with an access opening, which can be closed by means of a safety mechanism, e.g. a safety door. Thereby it is preferable that due to the parallel implementation or bypassing of the storage units, the storage unit is moved so close to the access opening that between the edges that point toward the protective covering and the protective covering itself, there is only a very small negligible space. This space can theoretically be set to zero, upon compliance with very stringent precision standards. This is only enabled by the parallel guiding at the apex of the transport conveyor or in the curved area of the transport conveyor. Due to this arrangement of the storage unit in the operating area, the grasping depth for the operator into the storage unit is improved considerably in comparison with conventional systems. The loading or picking of goods being transported or stored is considerably simplified and accelerated.

According to the invention, the width of the access opening corresponds to the width of the storage unit. This completely prevents injuries in this area. In this respect, the invention also differs significantly from systems according to the state of the art, where an edge oriented arrangement of the storage unit on the protective covering is not possible.

According to a preferable further embodiment of the invention, the access opening is located in the curved area of the transport conveyor and/or in the access area, parallel to the width of the storage units. This is a preferable variant. However, it does not rule out an angled or diagonal arrangement of the access opening in relation to the longitudinal direction of transport of the transport conveyor, due to a special design of the steering guide in the access area.

The invention also proposes that the drive is connected with the storage units and/or the shelf fields via at least one drive element. The drive element can be designed according to a further embodiment of the invention as a chain, as a cable, as a toothed belt, as a toothed chain, as a rubber eyelet chain, etc. The invention is limited in no way in this respect.

Furthermore, according to the invention, the guide element, in addition to the drive element, is driven by the drive. Corresponding to a further preferred embodiment, both the drive element for the transport conveyor and the guide element for the guide conveyor are driven jointly by the drive element. The drive speed of the transport and guide conveyor is synchronous, due to the common drive.

The invention also provides for the drive to be designed for reverse operation. This makes it possible for the control unit of the system to select the shortest path for the required storage unit to the access opening.

The control unit is designed so that it can detect the position of the storage units and when requested can select the shortest path to the access area or to the access opening.

The control unit is provided with interfaces that can be connected to storage management computers and to controlled picking systems and higher-level administrative systems. This makes it possible to use the advantages of such storage management computers and picking systems just as effectively as with known storage systems.

### BRIEF DESCRIPTION OF THE DRAWINGS

The invention is described in more detail below based on sample embodiments and drawings:

FIG. 1 Side view of a storage system according to an embodiment of the invention

FIG. 2 Top view of a storage system as in FIG. 1;

FIG. 3 Front view of a storage system as in FIG. 1;

FIG. 4 Detail of an embodiment of the steering guide;

FIG. 5 Schematic representation of the parallel arrangement of several storage systems according to an embodiment of the invention; and

FIGS. 6a and b provide details of an embodiment of the access opening according to the state of the art and according to the invention.

### DETAILED DESCRIPTION OF THE PREFERRED EMBODIMENT AND BEST MODE

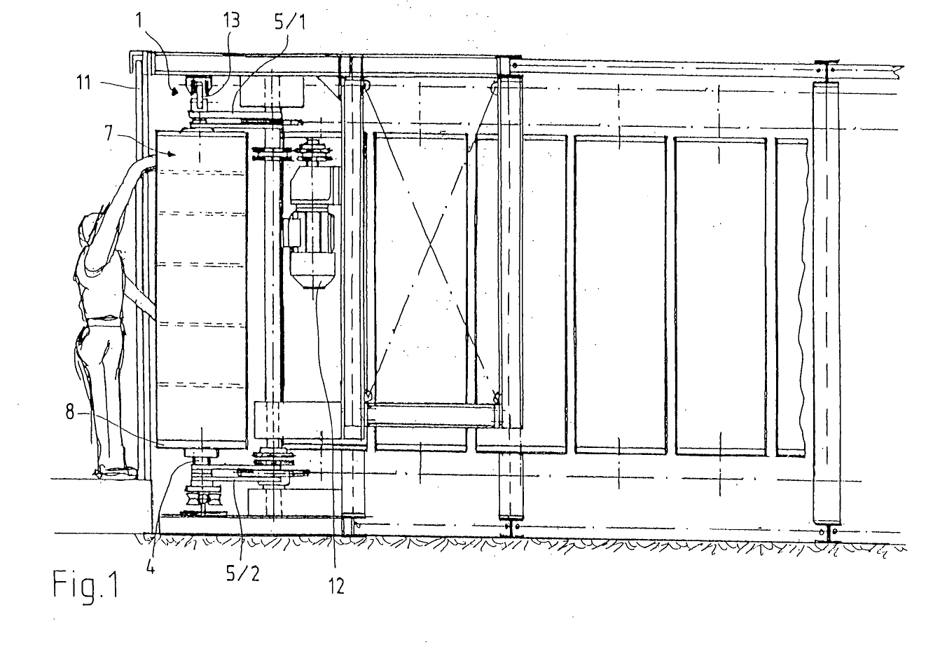

Referring now to the drawings, FIG. 1 shows a side view of a storage system according to an embodiment of the invention. Only the characteristics that are significant to the invention are designated. The entire storage system is located in a frame not further designated. The transport conveyor 1 is thereby fastened in the upper area of the frame. The transport conveyor 1 is for example provided with a drive element 13, which is connected by means of at least one steering rocker (5/1) in the upper area and by means of a further steering rocker (5/2) in the lower area both with the transport conveyor 1 and with the steering guide 4. The steering guide 4 has a rail-like design. Details of this rail-like design will be described further below. In the frame for the storage unit itself there is a drive 12, which is equipped with a gearbox and with shafts for driving the transport conveyor and for driving the steering guide 4. In the embodiment depicted in FIG. 1 the drive synchronously drives both the transport conveyor 1 and the steering guide 4. For this purpose, there are bearing blocks and a gearbox in the frame, which are not further designated. Between the transport conveyor 1 and the steering guide 4 there is a shelf field 7, which is enclosed by a frame 8. The storage units 2 not depicted in this drawing are located In the shelf field 7 during operation. In front of the access opening not further designated there is a safety door 11. This safety door 11 is located either on a frame not designated or on a protective cover not depicted in this drawing in order to protect the operator during movement of the shelf system.

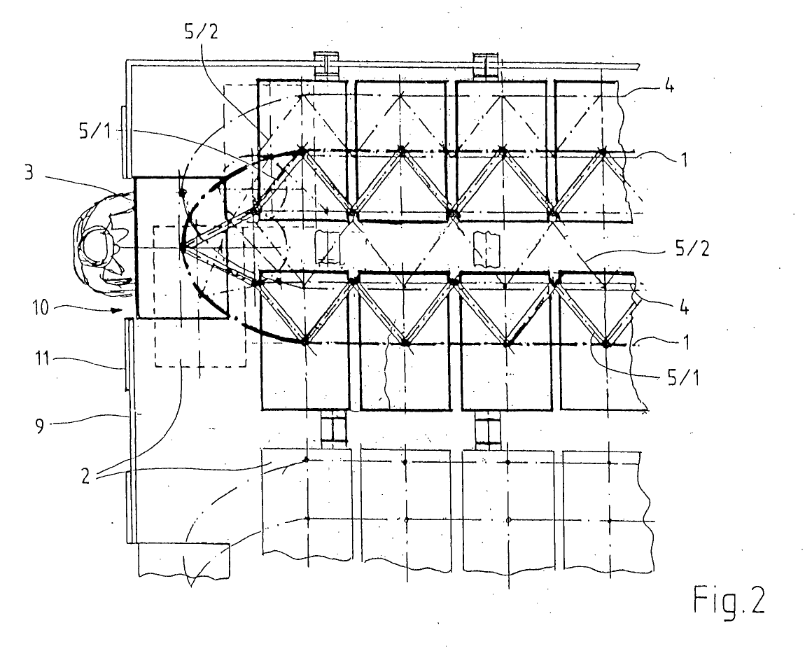

FIG. 2 shows a top view of a storage system according to FIG. 1 and a special embodiment according to the invention. In this depiction the advantages of the embodiment of the storage system according to the invention become evident. The transport conveyor 1 and the steering guide 4 are located hereby parallel to each other or essentially parallel to each other. Between the transport conveyor 1 and the storage unit 2 there is a two-part steering rocker 5/1. The steering rocker 5/1 is fastened to both the transport conveyor, on which it can rotate, and to the storage unit 1. The steering rocker is approximately triangular and is designed especially in the curved area of the transport conveyor 1 such that the two rotation or swivel points can move toward each other and away from each other on the transport conveyor. The parallel oriented movement of the storage unit 2 is enabled only by this. Steering rockers 5/2 are likewise located on the steering guide 4 (indicated by hatching). They are located beneath the shelf system or the storage unit 2. The location of the steering rockers 5/2 on the steering guide 4 achieves an extremely safe guide in the curved area of the transport conveyor. It becomes especially clear that the protective cover 9 can be moved as close as possible to the storage unit 2, which is located exactly at the summit of the curved transport conveyor 1. This arrangement not only saves space but also increases safety for the operator. In addition, for further increasing operator safety, there is a safety door 11 located at the access opening 10, which can be designed as a sliding door and which is closed during rotation of the storage units 2. It is apparent that the operator must not enter the swivel area or the safety area in order to access the storage unit 2. In the same manner, the depiction in FIG. 2 clearly shows that the centrifugal effect during turning of the storage unit 2 does not occur here, because this storage unit 2 is not turned via the radius, but is oriented parallel to it. The relative movement on the radius is therefore considerably smaller than in known solutions according to the state of the art, in which the transport of the storage unit 2 on the transport conveyor 1 is fixed and therefore at an angle to the latter, so that when rotating, a considerably higher relative speed occurs in the outer radius area than in the inner area. This is improved considerably by the solution according to the invention. In the drawing it is furthermore apparent that according to the invention it is possible to arrange several storage systems next to each other. In the same manner it is of course also possible to couple or link fixed storage units with the storage system according to the invention that have no movable supply systems.

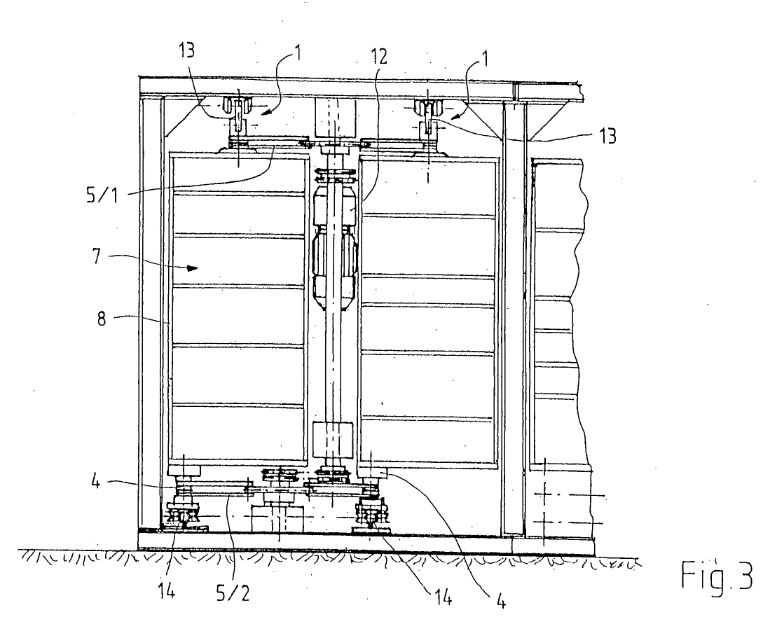

FIG. 3 shows a top view of a storage system according to the invention and according to FIG. 1. The reference numbers introduced above have been used in the same manner here. Concerning the front view it is pointed out that the parallel arrangement of the transport conveyor 1 and the steering guide 4 can be seen very well here. Between the transport conveyor 1 and the storage unit 4 there is a shelf field 7. The shelf field 7 is likewise enclosed by the frame 8 described above. The drive 12 is located between the two sides of the storage system and drives both the transport conveyor and the steering guide 4. There is a guide rail designated 14 in the lower area, in addition to the other embodiments. The shelf field is likewise transported and guided by means of the steering rockers 5/1, which connect the transport conveyor 1 with the shelf field 7, and by the steering rockers 5/2, which are located between the transport conveyor and the shelf field. A drive element not further described is designated 13. This element can be designed as a chain, cable, toothed belt, toothed chain or rubber eyelet chain, etc. The invention is limited in no way in this respect.

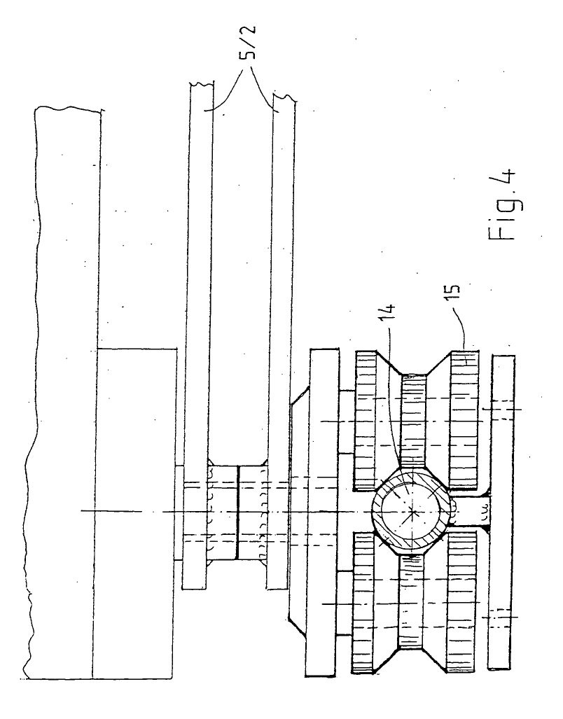

FIG. 4 shows a detail of a possible embodiment of the steering guide. The steering guide thereby consists in particular of the guide rail 14. The guide rail 14 guides the guide rollers 15, which are located either on the storage unit 2 or in the lower area of the shelf field 7. The steering rockers 5/2 guide the storage unit 2 or the shelf field 7 in the lower area.

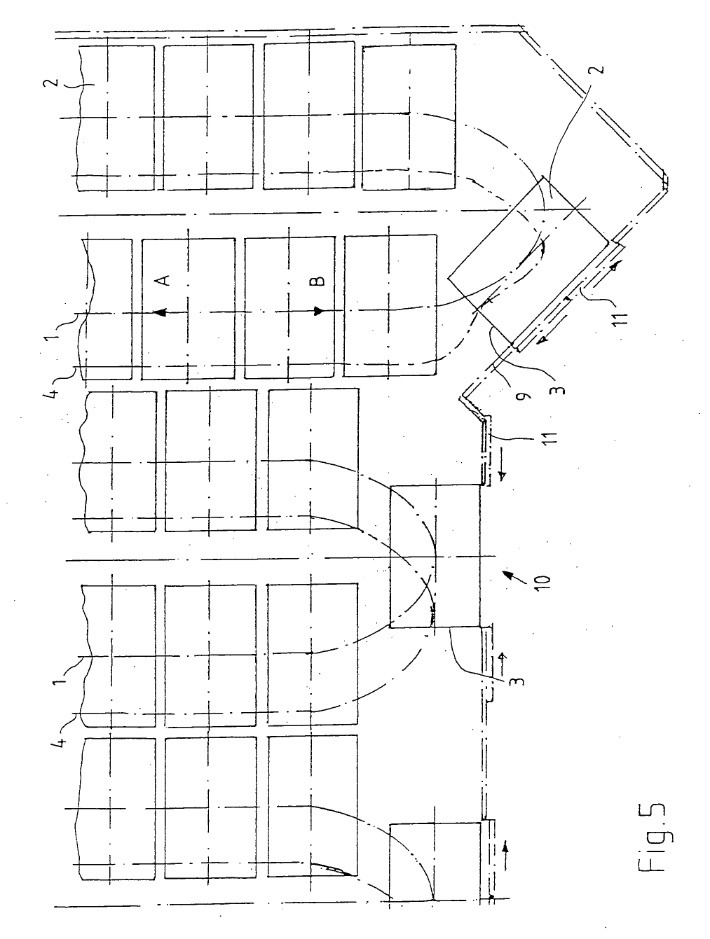

FIG. 5 shows a schematic representation of the parallel arrangement of several storage systems according to the invention. A total of three such storage systems are depicted here. The reference letters A and B in the depiction on the right indicate that reverse operation is possible. This reverse operation makes it possible for the control unit of the system to select the shortest path for the required storage unit to the access opening or to the storage location. The transport conveyor is again designated 1 in this depiction. The steering guide is again designated 4, and the storage unit is designated 2. The access opening 10 is parallel oriented on the storage system depicted at the left, while it is diagonally oriented in the storage system on the right. The operator or access area 3 is designed differently in the two systems. The protective cover is again designated 9. The safety door designated 11 can be designed as a sliding door, for example.

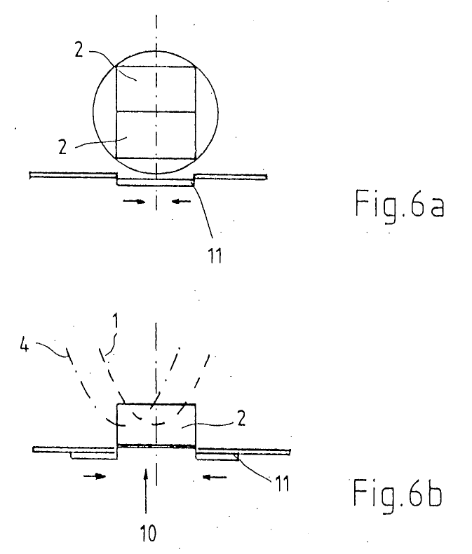

FIGS. 6a and 6b show a detail of the embodiment of the access opening according to the state of the art for carousels and according to the invention. In existing systems a certain distance is necessary to enable a turning or swiveling movement of the storage units 2 in the access area. This results in an increased space requirement according to state of the art systems. In particular, however, it becomes apparent that the operator cannot access the storage unit 2 directly without reaching into the access area. This results in disadvantages in user convenience.

In contrast, FIG. 6b shows that the outer radius of the storage unit 2 in the curved area of the transport conveyor or in the access area 3 is such that in operating position the distance between the side of the storage unit 2 facing the protective cover 9 and the protective cover 9 is zero or nearly zero. This increases the overall accessibility of the storage units 2. The access times are reduced by the embodiment according to the invention.

A storage system is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. A storage system, comprising a plurality of storage units located on a transport conveyor that has at least a U-shaped or randomly partially curved design, the storage units being arranged similarly parallel at least along straight areas of the transport conveyor and the storage units can be rotated on swivel axes that are oriented essentially at a right angle to the transport conveyor, characterized in that during the movement of the storage unit (2) into the curved area of the transport conveyor the storage unit (2) remains essentially parallel to the next storage unit (2) and swivels on the swivel axis of the moved storage unit (2).

2. Storage system according to claim 1, characterized in that at least one guide mechanism is provided for that in combination with the transport conveyor (1) and guide means located on the storage units (2) in the curved area of the transport conveyor and/or in an access area (3), the storage units (2) are likewise transported in parallel orientation.

3. Storage system according to claim 1 or 2, characterized in that the guide mechanism consists of at least one steering guide (4) and at least one pivoted steering rocker (5) located on each of the storage units (2) and on the transport conveyor (1).

4. Storage system according to claim 1, characterized in that at least two steering rockers (5) are provided for each storage unit (2) that can move toward and away from each other on the transport conveyor (1), especially in the curved area of the transport conveyor, and which have a common turning axis (6) on the storage unit (2).

5. Storage system according to claim 1, characterized in that the storage units (2) are designed so that they can be coupled to and uncoupled from the transport conveyor (1).

6. Storage system according to claim 1, characterized in that the storage units (2) and the transport conveyor (1) have interfaces for coupling and uncoupling.

7. Storage system according to claim 1, characterized in that the steering guide (4) and the transport conveyor (1) are arranged parallel to each other.

8. Storage system according to claim 1, characterized in that the transport conveyor (1) comprises a rail.

9. Storage system according to claim 1, characterized in that steering rockers (5) are located both between the transport conveyor (1) and the storage unit (2) and between the steering guide (4) and the storage unit (2).

10. Storage system according to claim 1, characterized in that the steering guide (4) comprises a guide rail (14).

11. Storage system according to claim 1, characterized in that several storage units (2) are located one above the other in a shelf field (7) and the transport conveyor (1) and the guide mechanism engages at least on the upper or lower storage unit (2) of the shelf field (7) or on the shelf field (7) itself.

12. Storage system according to claim 11, characterized in that the shelf field (7) encloses a frame (8), which accommodates several storage units (2) and which possesses the guide and transport means that work together with the transport conveyor (1) and the guide mechanism.

13. Storage system according to claim 2, characterized in that the access area (3) is provided with a protective cover (9).

14. Storage system according to claim 13, characterized in that the protective cover (9) has an access opening (10), which can be closed by means of a safety mechanism, for example a safety door (11).

15. Storage system according to claim 14, characterized in that the width of the access opening (10) corresponds to the width of the storage unit (2).

16. Storage system according to claim 14, characterized in that the access opening (10) is located in the curved area of the transport conveyor and/or in the access area (3) parallel to the width of the storage units (2).

17. Storage system according to claim 13, characterized in that the outer radius of the storage unit (2) in the curved area of the transport conveyor or in the access area (3) is such that in operating position the distance between the side of the storage unit (2) facing the protective cover (9) and the protective cover 9 is zero or nearly zero.

18. Storage system according to claim 14, characterized in that the steering guide (4) in the access area (3) is designed so as to enable the angular or diagonal orientation of the access opening (10).

19. Storage system according to claim 11, characterized in that a drive (12) is provided, and is connected by at least one drive element (13) with the storage units (2) and/or the shelf fields (7).

20. Storage system according to claim 19, characterized in that the drive element (13) is selected from the group consisting of a chain, cable, toothed belt, toothed chain, rubber eyelet chain.

21. Storage system according to claim 19, characterized in that the drive (12) is designed for reverse operation.

22. Storage system according to claim 11, characterized in that a control unit is provided for by means of which the drive (12) and/or the storage unit (2) can be controlled.

23. Storage system according to claim 22, characterized in that the control unit can detect the position of the storage units (2) and when requested can select the shortest path to the access area (3) or to the access opening (10).

24. Storage system according to claim 22, characterized in that the control unit optimizes the transport path of a storage unit (2) before it is requested or moved.

25. Storage system according to claim 22, characterized in that the control unit has interfaces for linking with at least one storage management computer and/or one controlled picking system.

26. Storage system according to claim 22, characterized in that each storage unit (2) is allocated to at least one code, for example a barcode, which is detected by the control unit.

27. Storage system, comprising at least two transport conveyors according to claim 1.
